(19) United States
(12) Patent Application Publication
(10) Pub. No.: US 2008/0296865 A1
(43) Pub. Date: Dec. 4, 2008

(54) Wheel-Equipped Stand for a Two-Wheeled Vehicle

(76) Inventor: Marcel Canetti, Meudon (FR)

Correspondence Address: GREER, BURNS & CRAIN, 300 S WACKER DR, 25TH FLOOR, CHICAGO, IL, 60606, US

(21) Appl. No.: 12/095,235

(22) PCT Filed: Nov. 24, 2006
(86) PCT No.: PCT/FR2006/002580

§ 371 Date: May 28, 2008

(30) Foreign Application Priority Data
Nov. 29, 2005 (FR) 05/12047

(51) Int. Cl. B62H 1/12; B62K 3/12

(52) U.S. Cl. 280/301; 280/63

(57) ABSTRACT

A stand device, for a two-wheeled vehicle, including at least one rotatably mobile stand arm and a retractable pin fixed at least indirectly to the stand arm, the stand device being intended to be mounted on the two-wheeler so that the arm is rotatably mobile between a high position and a low position, the pin having an active position in which it can block the course of a pedal arm and a retracted position in which it does not block the course of the pedal arm.

The present invention relates to a stand device for stabilizing a vehicle comprising at least two in-line wheels, in particular a bicycle. The term “two-wheeler” will be used non-limitatively herein to designate such a vehicle, the invention being applicable in particular to vehicles comprising more than two in-line wheels.

The purpose of the invention is in particular to propose a device enabling riders of two-wheelers to stop without needing to place the foot or feet on the ground to maintain balance, by coming into operation before the vehicle has completely stopped. It is also to propose a device making available a wheeled centre stand which can be deployed in particular when the vehicle user is not riding the vehicle, for example when moving beside the two-wheeler whilst holding it.

In particular, such a device must advantageously be capable of being deployed when the user is moving, without the hands leaving the handlebars, which can be dangerous, as it can cause loss of balance and/or an uncontrolled change of direction. Moreover, it can also be advantageous if the two-wheeler is a bicycle, otherwise known as a cycle, for the operation of such a device to be carried out without the feet of the cyclist leaving the pedals, in particular to retain full traction, and therefore balance.

According to the invention, such a stand device for a two-wheeled vehicle comprises at least one rotatably mobile stand arm and a retractable pin fixed at least indirectly to the stand arm, said stand device being intended to be mounted on the two-wheeler so that the arm is rotatably mobile between a high position and a low position, said pin having an active position in which it blocks the course of a pedal arm and a retracted position in which it does not block the course of said pedal arm. Thus when during its rotary movement the pedal arm comes into contact with the pin, the pedal arm tends to drive the stand arm in rotation. According to the direction of pedalling, the stand arm is thus moved towards its high position or towards its low position.

Such a device advantageously comprises means of control. These means of control can comprise a lever, which can be a brake-type lever, fixed on the handlebars and connected by a cable to the pin, so that an action on the lever causes the pin to adopt its active position, opposite to the action of the means for retracting the pin, said means for retraction being provided to push the pin towards its retracted position when no action is exerted on said control lever. The means of control can also comprise a handle rigidly connected to the stand arm and extending substantially upwards, so as to be accessible to the hand of a user of the two-wheeler. The use of the lever control on the handlebars thus makes it possible to activate the pin without the user removing a hand from the handlebars or a foot from a pedal. Moreover, the use of the handle makes it possible to deploy the device, particularly when the user is not riding the two-wheeler, therefore not using the pedals.

Such a device can also comprise means for retaining the stand arm in its high position. These retaining means can comprise a retaining spring intended to be fixed firstly to the arm and secondly to the frame of said two-wheeler. These retaining means can also comprise an upper spring clip, i.e. intended for retaining in the high position, intended to be fixed to the frame of said two-wheeler and to engage at least indirectly with the arm. If the device comprises each of the retaining means, when the arm is engaged by the upper clip, the high position is a position in which the arm is completely lifted, and in that when the arm is only retained by the retaining spring, the high position is an intermediate position. Therefore, strictly speaking the spring does not constitute a retraction means for the stand device, but principally a retention means when the device has been moved towards its high position by the friction of the wheels against the ground or by the action of the pedal arm on the pin. The handle can be used to change from the intermediate high position to the fully lifted high position in the upper clip, and thus complete the lifting of the device. The upper clip in particular makes it possible to avoid movements of the stand device, for example in response to unevenness of the ground travelled over.

To provide for vehicle movement when the stand arm is in low position, it is advantageous to provide a wheel mounted rotatably on each arm, for wheeling on the ground when the arm is in its low position.

The device can be sold separately from the two-wheeler, with assembly means, for mounting on a two-wheeler.

The invention also relates to a two-wheeler equipped with such a stand device, whether originally or otherwise.

Other features and advantages of the invention will also become apparent from the description below, which relates to non-limitative examples.

In the attached drawings:

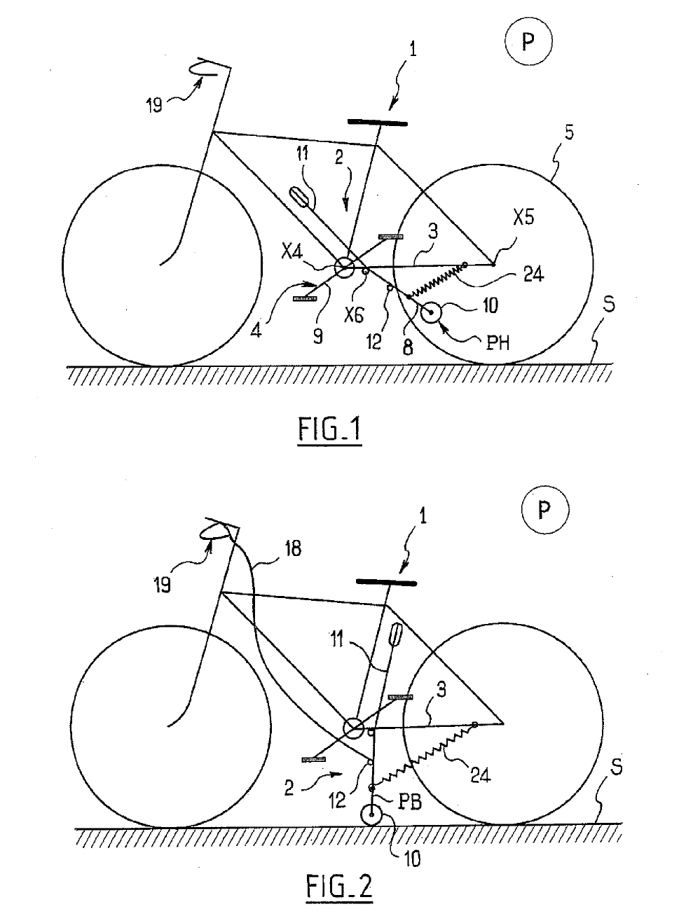

FIG. 1 is a diagrammatic representation of a side elevation of a cycle equipped with a stand device according to the invention, the device being shown in a high position;

FIG. 2 is a diagrammatic representation of a side elevation of a cycle of FIG. 1, the device being shown in a low position;

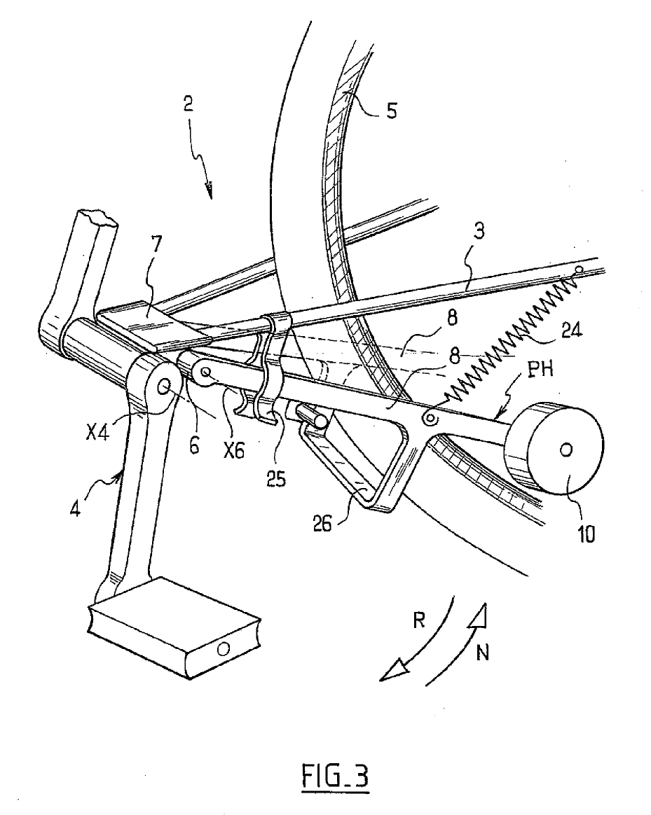

FIG. 3 is a diagrammatic perspective view of a part of the device of FIGS. 1 and 2;

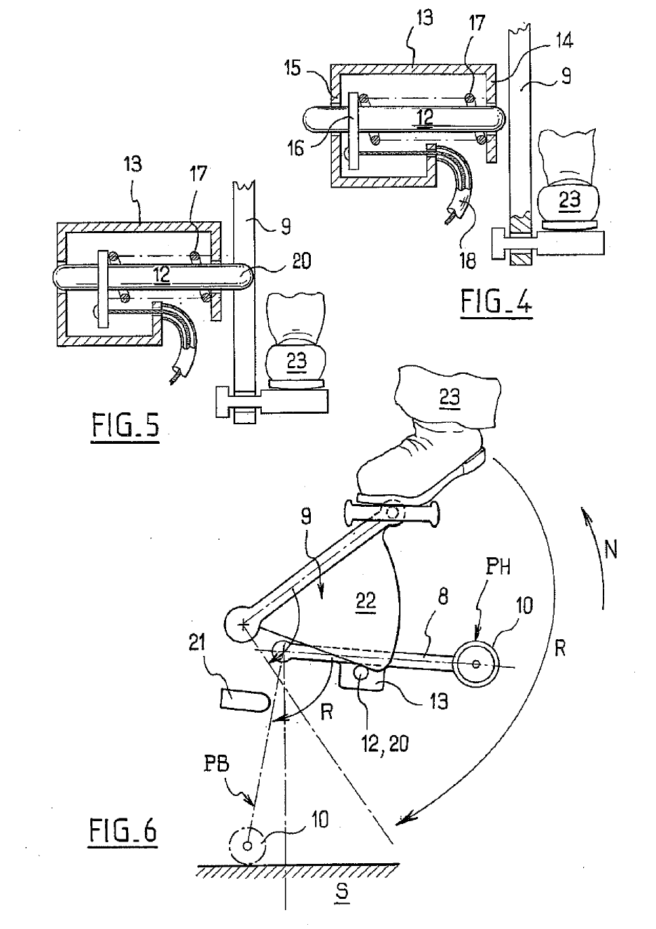

FIGS. 4 and 5 are diagrammatic representations of the operation of the pin, shown respectively in a retracted position and in an active position; and,

FIG. 6 is a diagrammatic elevation view of a device according to the invention, in an embodiment for which the pedal arm comprises a cam.

FIG. 1 shows a cycle 1 equipped with a device 2 according to the invention. The device is fixed to a rear fork 3 of the cycle 1, which extends substantially from the axis X4 of the pedal set 4 to the axe X5 of the rear wheel 5.

The device 2 comprises a pivot point 6 forming a pivot 6 about an axis X6 of the stand, parallel to the axis X4 of the pedal set. The pivot point is placed immediately under the fork 3 and to the rear of the axis X4 of the pedal set. It can be fixed under the fork by welding, in particular if the device is originally mounted on the cycle. In the example particularly illustrated in FIG. 3, the pivot point i s fixed using a backplate 7.

The device 2 moreover comprises two stand arms 8 which extend from the pivot point 6, on each side of a mid-plane P of the cycle 1, but inside the courses of the arms 9 of the pedal set 4. Thus during the pedalling action, the pedal arms are moved rotatably on each side of the stand arm. The device also comprises a roller 10 at one end of each stand arm, at the opposite end to the pivot point 6. The mid-plane is a plane parallel to the plane of FIG. 1, and forming substantially a plane of symmetry for the cycle frame.

The device 2 also comprises a handle 11, rigidly connected to the stand arm. The handle 11 extending substantially parallel to the mid-plane, in a direction substantially opposite to that of the stand arms.

The device 2 also comprises a tension spring 24, attached firstly to one of the stand arms 8, and secondly to the fork 3, close to the wheel axis X5, so that it pulls the stand arms 8 into their high position PH illustrated in FIG. 1.

The device 2 comprises more particularly an extended pin 12 (see in particular FIGS. 4 and 5). This pin 12 is slidably mounted on a pin support 13. The support 13 is rigidly connected to the stand arms, so that it moves rotatably about the axis X6 of the stand, at the same time as the stand arm 8. The pin is intended to move in its support 13, substantially transversally in relation to the mid-plane P, two opposite walls 14, 15 of the stand 13 together forming a bearing for the pin 12. The pin is formed in a single piece with a collar 16, positioned between the two walls 14, 15. A helical spring 17 is mounted around the pin, pre-stressed between a first 14 of the support walls 13 and the collar 16, so that it pushes the collar in the direction of the second wall 15. The collar 16 is also used to attach one end of a sheathed cable 18, of the cycle brake cable type, the other end of the cable 18 being connected, as represented diagrammatically in FIG. 2, to a lever 19, also of the type used for cycle brakes. The cable is mounted so that an action on the lever tensions the cable so that the pin 12 is moved against the action of the spring 17, compressing the latter. Thus an active end 20 of the pin 12 extends through the first wall 14, so that the active end 20 blocks the course of the pedal arm 9, as particularly represented in FIG. 5. When no pressure is exerted on the lever 19, the pin remains in a retracted position illustrated in FIG. 4.

Thus while the pedal arm 9 is in contact with the pin 12, the pin and therefore the stand arms 8 to which the pin is connected, are driven jointly in rotation with the pedal set. Thus as particularly illustrated in FIG. 6 by solid lines, when the pin is in its active position, a back-pedalling in the direction R firstly brings the pedal arm into contact with the active end 20 of the pin. Continuing to back-pedal, with the pin maintained in its active position, causes the movement of the stand arms 8 to their low position PB, represented by dotted lines. In the embodiment illustrated, the low position is situated beyond the vertical V, relative to the high position PH. Thus when the rollers 10 come into contact with the ground S, particularly while passing the vertical, it causes a slight lifting of the cycle 1. In the low position PB, the device rests against a stop 21, so that the arms cannot move beyond the low position PB, and remain immobilized between the opposing effects of the ground and the stop.

Although this is not necessary, the shaft of the pedal set 8 illustrated in FIG. 6 comprises a cam 22 which extends along the course of the pedal set shaft, in the direction of back-pedalling R. This cam 22 makes it possible to anticipate the contact of the pedal arm and of the active end 20 the pin 12, so that during the deployment of the device, and particularly when passing the vertical V, the cyclist's foot 23 has a substantially upward movement, thus allowing greater power to be developed, and therefore making it easier to deploy the device 2.

Two solutions can be used for returning the stand arms from their low position to their high position.

According to a first solution, the pin can be placed in its active position by the same action on the lever 19, and pedalling in the normal direction N so as to move the cycle forward, the reverse of the back-pedalling direction R. Then the pedal arm 8 comes into contact from the front with the active end 20 of the pin 12, and drives the device 2 towards its high position PH. Advantageously, an upper spring clip 25 is provided, illustrated in the enlarged view in FIG. 3, arranged so that in the high position as illustrated in FIG. 3, a stand arm 8 is latched into the upper clip 25 and is held firmly in place there. The use of the pin 12 to return the arms 8 to their high position, enables a force sufficient to allow latching, to be produced by pedalling.

The second solution consists of leaving the pin in its retracted position of FIG. 4. During an acceleration of the cycle beyond a certain speed, the frictional forces of the ground against the wheels are such that the arms are pushed then driven beyond the vertical V. Then, their movement is continued until reaching a high position under the action of the spring 24. In the embodiment described, the spring 24 is essentially a spring for retaining the device in this intermediate position. The spring is not intended to provide too great an opposing force during deployment of the device. Consequently it is sufficient to lift the device but does not allow latching into the upper clip 25. This latching can be obtained as previously, by placing the pin in its active position, or by use of the handle 11.

The handle 11 can be used more particularly when the cyclist is not riding the cycle and thus unable to use the interaction of the pin and the pedal set to move the device 2 between its high and low positions.

The two arms are held together, in particular to prevent them from spreading out under the weight of the cyclist, by a cross member 26. This cross member is in the shape of a “U”, each arm of which is connected to a respective stand arm. It is arranged so that in the high position PH illustrated in FIG. 3, it provides a passage for the wheel 5, while allowing a position of the rollers on each-side of this wheel. Thus in the high position PH, even if the rollers are particularly spaced apart, they do not inconvenience the cyclist, particularly when the cycle is tilted or when it is moving alongside an obstacle such as a pavement. Such an arrangement is particularly advantageous, since a wider spacing apart of the rollers allows a greater stability of the cycle when the device is in its low position.

Of course, the invention is not limited to the examples which have just been described, and numerous adjustments can be made to these examples without exceeding the scope of the invention.

In particular, instead of being moved in translation, the pin can also be designed to be moved in rotation.

A device according to the invention does not have to have a handle.

The upper clip can also be arranged differently, to enable the latching of another mobile part of the stand device.

The upper clip can also be dispensed with. The retaining spring can be sufficient to provide a complete lifting of the stand device, and to retain it immobilised against a stop.

It is not necessary to the operation of the device for the low position to be beyond the vertical relative to the high position. It is thus advantageous to provide a retaining device, to prevent the arms being moved towards the high position by the spring or the friction against the ground. These means of retention can take the form of a lower spring clip, i.e. provided to retain the device in the low position. The lower spring clip can be fixed to the frame of the two-wheeler and engage at least indirectly with the stand arm, when the arm is in its low position. The lower spring clip can be intended to oppose the force of the retaining spring, and during the forward movement of the two-wheeler, to a certain frictional force beyond which the device is released from engagement with the lower spring clip and returned to a position by the retaining spring.

Advantageously, the lever is arranged on a single handlebar grip of the cycle, opposite to a brake lever, so that the stand lever 19 can be operated by the thumb while the brake lever is simultaneously operated by the other fingers of the same hand.

A two-wheeler equipped with a device according to the invention can be used as a two-wheeler of the prior art, if the user does not wish to take advantage of the benefits of the stand device.

Also, it is noted that when the device is in place, in its low position, if the two-wheeler is left on a slope, the front wheel naturally adopts a transverse position, forming a brake and immobilizing the cycle, without the cycle falling over.

1. A stand device, for a two-wheeled vehicle, comprising: at least one rotatably mobile stand arm and a retractable pin fixed at least indirectly to the stand arm, said stand device being intended to be mounted on the two-wheeler so that the arm is rotatably mobile between a high position and a low position, said pin having an active position in which it can block the course of a pedal arm and a retracted position in which it does not block the course of said pedal arm.

2. The device according to claim 1, comprising means of control for moving the pin into its active position.

3. The device according to claim 2, wherein said means of control comprise a lever, which can be a brake type lever, intended to be fixed on the handlebars and connected by a cable to the pin, so that an action on the lever moves the pin into its active position, opposing the action of the means of retracting the pin, said retracting means being provided to push the pin towards its retracted position when no action is exerted on said control lever.

4. The device according to claim 2, wherein said means of control comprise a handle rigidly connected to the stand arm and extending substantially upwards, so as to be accessible to the hand of a two-wheeler user.

5. The device according to claim 1, comprising means for retaining the stand arm in its high position.

6. The device according to claim 5, wherein said retaining means comprise a retaining spring provided to be fixed firstly to the arm, and secondly to the chassis of said two-wheeler.

7. The device according to claim 5, wherein said retaining means comprise an upper spring clip intended to be fixed to the frame of said two-wheeler and to engage at least indirectly with the stand arm.

8. The device according to claim 1, comprising a spring clip to be fixed to the frame of said two-wheeler and to engage at least indirectly with the stand arm, when said arm is in its low position.

9. The device according to claim 1, further comprising, rotatably mounted on each arm, a roller intended to be able to roll on the ground when the arm is in its low position.

10. A two-wheeler equipped with a stand device according to claim 1.
